(19) United States
(12) Patent Application Publication
(10) Pub. No.: US 2026/0247510 A1
(43) Pub. Date: Aug. 20, 2026

(54) ULTRA-EFFICIENT DIMMABLE LED DRIVER

(71) Applicant: SIGNIFY HOLDING B.V., EINDHOVEN (NL)

(72) Inventors: THEO GERRIT ZIJLMAN, TILBURG (NL); WERNER FRIEDRICH HORIKX, EINDHOVEN (NL); ALEXANDER HENRICUS WALTHERUS VAN EEUWIJK, EINDHOVEN (NL); BERTRAND JOHAN EDWARD HONTELE, BREDA (NL); KARNEKUMAR ARULANDU, BREDA (NL); HAIMIN TAO, EINDHOVEN (NL)

(21) Appl. No.: 19/474,743

(22) PCT Filed: Apr. 8, 2024
(86) PCT No.: PCT/EP2024/059421

§ 371 Date: Oct. 13, 2025

(30) Foreign Application Priority Data
Apr. 11, 2023 (EP) 23167390.6

(51) Int. Cl. H05B 45/38; H05B 45/10; H05B 45/325; H05B 45/355; H05B 47/14; H05B 47/24

(52) U.S. Cl. CPC H05B 45/38; H05B 45/10; H05B 45/325; H05B 45/355; H05B 47/14; H05B 47/24

(57) ABSTRACT

The invention relates to a driver circuit for powering a light source. The driver circuit comprises a first driver adapted to provide power to the light source and having a first output power at a first optimum power conversion efficiency, a second driver adapted to provide power to the light source and having a second output power at a second optimum power conversion efficiency, a controller for enabling and disabling the first driver with a first duty cycle and the second driver with a second duty cycle. The controller is adapted to receive a dimming signal and arranged to determine the first duty cycle and the second duty based on a dimming signal such that the first driver operates at the first optimum power conversion efficiency and the second driver operates at the second optimum power conversion efficiency when active.

### FIELD OF THE INVENTION

The invention relates to a driver. The invention further relates to a lighting apparatus.

### BACKGROUND OF THE INVENTION

For the lighting industry, the requirements for energy efficiency become more challenging, especially with the new European Union energy labelling introduced on 1 Sep. 2021. This new labelling follows the trend of improvements in energy efficiency for lighting products. By then, more and more light sources achieved label ratings of A+ or A++, making it impossible for customers to see any light efficiency difference between products. With the new labelling, the light sources become more distributed over the labelling range again. This also means that lamps that were for example A++ rated in the old system are now labelled as C. It is therefore desired to further improve the energy efficiency of light sources.

Especially at dimmable light sources, there is a great desire to improve the efficiency. At dimming and especially deep dimming, the fixed losses in a driver e.g., losses caused in the control circuit, become a dominant part of the losses in a lighting apparatus. Drivers are generally designed for their rated power and the fixed losses are therefore also depending on the rated power of the driver. In general, a driver with a lower rated output power has also lower fixed power losses. This obviously impacts the total amount of power that can be provided to the load. A driver with a higher rated power can provide more power to its output, but this comes with more fixed losses. It is therefore desired to provide a lighting apparatus that can provide a good dimming function while operating at a very high efficiency.

### SUMMARY OF THE INVENTION

It is an objective of the invention to provide a solution that allows dimming to be performed while maintaining a good overall efficiency.

To provide such solution, in a first aspect of the invention, a driver circuit for driving a light source is provided. The driver circuit comprises:
a first driver adapted to provide power to the light source and having a first output power at a first optimum power conversion efficiency;
a second driver adapted to provide power to the light source and having a second output power at a second optimum power conversion efficiency;
a controller adapted to:
   generate a first control signal for enabling and disabling the first driver, the first control signal having a first duty cycle, and
   generate a second control signal for enabling and disabling the second driver, the second control signal having a second duty cycle,
wherein the controller is adapted to receive a dimming signal and arranged to determine the first duty cycle and the second duty cycle based on a dimming signal such that the first driver operates at the first optimum power conversion efficiency and the second driver operates at the second optimum power conversion efficiency when active, wherein the first control signal and the second control signal have a frequency of at least 100 Hz.

A first driver and a second driver are provided. Both drivers provide power to the same light source. Each driver has an output power at which they operate at an optimum conversion efficiency. This means that the drivers are designed to provide the output power at the highest efficiency that the driver can provide power to the light source. A controller is used for controlling the first and second driver. The controller generates a first control signal and a second control signal so that the controller can enable and disable the first driver and the second driver. The controller also receives a dimming signal. The dimming signal may be any kind of dimming signal that is used in the lighting industry. Examples of dimming signals are phase-cut dimming signals, 0-10 V dimming signals, DALI dimming signals, DMX dimming signals or wireless dimming signals. The controller uses the dimming signal to determine at which duty cycle each of the drivers is to operate i.e., at which duty cycle is each of the drivers enabled. When the drivers are enabled, they preferably provide their corresponding powers to the load at their optimum power conversion efficiencies. This allows the powers of the drivers to be combined to the load, while when the drivers are powering the load, this is done in an energy efficient way. Controlling the duty cycles of the drivers to be enabled allows a power to the load to be varied, while keeping the overall efficiency of the driver circuit high. In an example where two drivers are used and both are arranged to provide a similar amount of power to the light source, the first driver may be used to provide a variable power between a dimming level of 0% to 50%. The duty cycle of the first driver may then accordingly vary between 0% and 100%. Preferably, after a dimming level of 50% where the first driver is operated at a duty cycle of 100%, the second driver may be included in powering the light source. Between the dimming level of 50% and 100%, the second driver may be operated with a corresponding duty cycle between 0% and 100%. Providing the first control signal and the second control signal having a frequency of at least 100 Hz allows to provide a robust control of the drivers, while not impacting the light quality.

In a further example, the driver circuit comprises a third driver adapted to provide power to the light source and having a third output power at a third optimum power conversion efficiency, wherein the controller is for enabling and disabling the third driver with a third duty cycle and adapted to determine the third duty cycle based on the dimming signal such that the third driver operates at the third optimum power conversion efficiency when active.

A third driver allows the total power to the light source to be increased or the drivers to be made smaller since each driver may then have a lower power rating.

In an example where three drivers are used and they are arranged to provide a similar amount of power to the light source, the first driver may be used to provide a variable power between a dimming level of 0% to 33.33%. The duty cycle of the first driver may then accordingly vary between 0% and 100%. Preferably, after a dimming level of 33.33% where the first driver is operated at a duty cycle of 100%, the second driver may be included in powering the light source. Between the dimming level of 33.33% and 66.67%, the second driver may be operated with a corresponding duty cycle between 0% and 100%. Preferably, after a dimming level of 66.67% where the first driver and the second driver are operated at a duty cycle of 100%, the third driver may be included in powering the light source. Between the dimming level of 66.67% and 100%, the third driver may be operated with a corresponding duty cycle between 0% and 100%.

In a further example, the first driver and the second driver are arranged have identical rated powers.

Preferably, all drivers have an identical rated power for powering the light source. Preferably, the first driver and the second driver provide a substantial similar amount of power to the light source. This allows the drivers to be designed as identical modules. This greatly simplifies the design of the driver circuit.

In a further example, the first driver and the second driver are arranged to have different rated powers from each other.

At e.g. deep dimming, the dimming steps may be much better perceivable by an observer. Providing a first driver having a lower rated power than a second driver may be preferred. As an example, the first driver may have a rated power of 1 W and the second driver a rated power of 9 W, resulting in a total power of 10 W. this 10 W may e.g. be divided over the dimming range in a linear way such that over a dimming level between 0% to 100%, the power to the light source may vary between 0 W and 10 W respectively. The first driver may be used in the dimming range between 0% and 10%, where the first driver may be operated with a corresponding duty cycle between 0% and 100%. The first driver may not be able to be enabled with a duty cycle with infinite steps. Instead, the duty cycle itself has a resolution. As an extremely exaggerated example, there may be only 10 duty cycle steps provided. These steps are then mapped over the power range that can be provided by the driver. In this example, a duty cycle of 0% corresponds to 0 W provided to the light source and a duty cycle of 100% may then relate to 1 W provided to the light source. Every duty cycle step will increase the power to the load by 100 mW. The minimum power that can be provided to the light source is then 100 mW. If the second driver were to be used in this dimming range, assuming a similar amount of duty cycle steps, only a minimum power of 900 mW would be possible. It is therefore desired to use the driver with the lowest rated power at the deepest dimming levels, such that a lowest minimum power can be provided to the light source by the driver circuit.

In a further example, the first driver and/or the second driver are non-dimmable.

If the drivers are non-dimmable, the drivers are arranged to provide a fixed amount of power. The drivers can therefore only provide one power level, which may be at the rated power of the drivers. The drivers have an optimum power efficiency since the drivers are optimized in the design to provide this single amount of power at an efficiency as high as possible. The average power provided by the driver circuit is therefore dependent on the duty cycle at which each driver enabled/active.

In a further example, the driver circuit further comprises a capacitor and a switching element wherein the capacitor and the switching element form a series configuration between a first input of the first driver and a second input of the first driver.

Providing a switchable capacitor at the input of the drivers allows disturbances caused by the enabling and disabling of the drivers to be compensated. As an example, when none of the drivers draws a current from e.g., an AC input at a specific moment in time, the capacitor can be connected to the AC input voltage to allow the desired current to be drawn.

In a further example, the driver circuit is arranged to receive an AC voltage and wherein the switching element is arranged to be closed when a voltage across the capacitor exceeds an amplitude of the AC voltage.

If the capacitor is charged, the current from the capacitor can be provided to the drivers when the capacitor voltage exceeds the AC input voltage.

In a further example, the driver circuit comprises an auxiliary driver, adapted to power the controller and adapted to be electrically separated from the light source.

The controller normally requires its own power supply. The controller has its own power requirements. It is therefore desired to provide an auxiliary driver that has its power efficiency optimized for the power consumed by the controller. This can be done when the auxiliary driver is used for only powering the controller. It is preferred to electrically separate the auxiliary driver from the light source so that the auxiliary driver is unable to power the light source.

In a further example, the driver circuit comprises a further auxiliary driver, wherein the further auxiliary driver is adapted to power the controller when the driver circuit is in a standby mode.

In standby, the controller may consume a lower power than during normal operation. It is preferred to also provide a good power efficiency during a standby mode of the driver circuit. A further auxiliary driver may have its power efficiency optimized for the power consumed by the controller during standby. During standby, the controller may e.g. still be active for receiving wireless control signals.

In a further example, at a dimming level, where the first driver and the second driver provide power to the light source, the first driver and the second driver operate in an interleaved mode of operation.

It is desired to have at a dimming level, where both drivers provide power at their optimized power efficiency, that the drivers operate in an interleaved operation mode. The controller can control the two drivers such that they operate with a relative phase delay. The phase delay is preferably 180 degrees when two drivers are used or

$$\frac{360 °}{n}$$

for any number of n drivers. This results in a ripple in the output current with a double frequency but with a reduced peak-peak amplitude.

In a further example, the controller is arranged to control the first driver to operate at a duty cycle of 100% and the second driver at a duty cycle between 0% and 100% from a dimming level representing a required power for the light source exceeding a rated power of the first driver.

When the dimming level relates to a desired power to the light source exceeding the rated power of the first driver, the controller may regulate the first driver to provide its maximum rated power and additionally regulate the second driver to provide additional power, such that the desired power level is provided to the light source.

In a further example, the controller is arranged to enable the first driver and the second driver by providing a control signal to the first driver and the second driver and wherein the controller is arranged to disable the first driver and the second driver by not providing the control signal to the first driver and the second driver.

The controller C may for example provide an enable or disable signal to each of the drivers for controlling the enabling and disabling of the drivers.

In another example, a lighting apparatus is provided. The lighting apparatus comprises:
a driver circuit according to any of the preceding examples; and
the light source.

In another example, the wherein the controller is arranged to control the first driver and the second driver based on the dimming level such that an efficacy of the lighting apparatus increases when the dimming level decreases.

Preferably, the efficacy of the lighting apparatus increases when dimming. This can be done by turning one driver off when the dimming level is at a level that e.g. only one driver is required for powering the light source. The light source is configured to receive then only the current from the first driver, while no current is provided by the second driver. This means that less current is provided to the light source, resulting in a reduced current density in the light source. The light source has an improved efficacy at a reduced current density and therefore the efficiency of the lighting apparatus is improved.

In another example, the light source is a semiconductor light source, preferably an LED load, more preferably in the form of a filament.

Preferably, the light source is a semiconductor light source. Examples of semiconductor loads are LEDs, laser diodes and vertical-cavity surface-emitting lasers, VCSEL. Preferably, the LEDs are formed as a filament.

### BRIEF DESCRIPTION OF THE DRAWINGS

Examples of the invention will now be described with reference to the accompanying drawings, in which:

FIG. 1 shows an example of a circuit diagram.

FIG. 2 shows another example of a circuit diagram.

FIG. 3 shows another example of a circuit diagram.

FIG. 4 shows another example of a circuit diagram.

FIG. 5 shows another example of a circuit diagram.

FIG. 6 shows another example of a circuit diagram.

FIG. 7 shows another example of a circuit diagram.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should also be understood that the Figures are merely schematic and are not drawn to scale. It should also be understood that the same reference numerals are used throughout the Figures to indicate the same or similar parts.

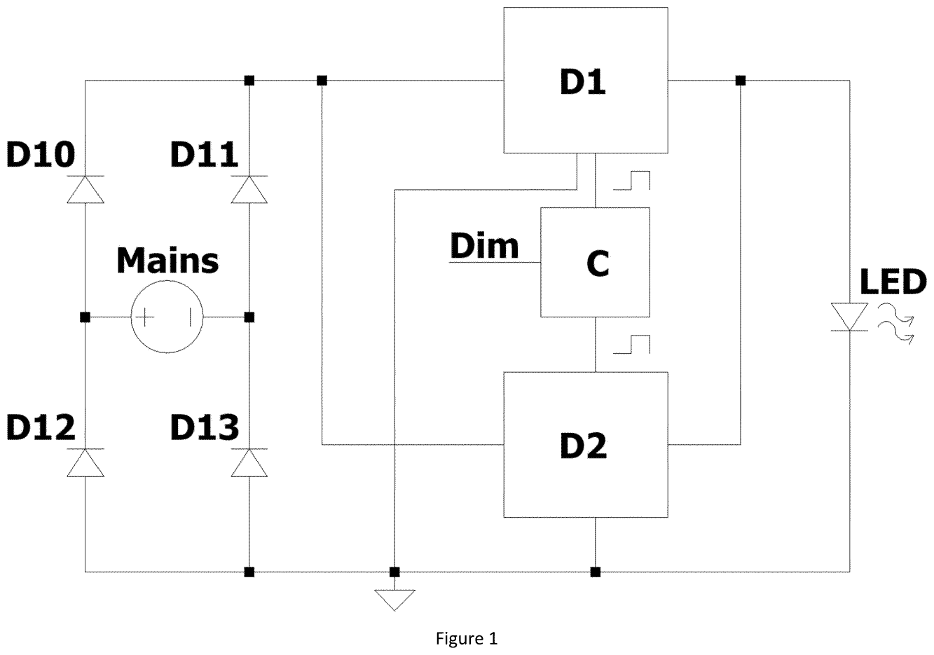

FIG. 1 shows an example of a circuit diagram of a lighting apparatus having a driver circuit that provides an output power to the light source LED. The driver circuit may be coupled to mains via a rectifier circuit having four diodes D10, D11, D12 and D13. The rectifier circuit provides a rectified mains voltage. In the example provided, a first driver D1 and a second driver D2 receive the rectified mains voltage. A controller C is used to control the first driver D1 and the second driver D2. The controller C may receive a dimming signal Dim. The dimming signal Dim may be provided by a dimmer or an external device providing dimming commands. Examples of devices that can provide the dimming signal are phase-cut dimmers, 0-10 V dimmers, DALI dimmers, DMX dimmers or wireless remote devices for providing dimming signals. The first driver D1 and the second driver D2 are arranged to provide power to the same load, which is in this example a light source LED.

The light source LED has a first input to which the output of the first driver D1 and the output of the second driver D2 are coupled. Preferably, the light source LED is an LED light source. The LED light source may be a string of LEDs coupled in series, preferably forming a filament. Other devices or a combination of devices may also be coupled in series such as laser diodes or VCSEL. For the sake of clarity, the examples show LEDs as the light source. Preferably, the size of the LED string cannot be changed. This means that the LED string has only one input and one return for receiving a current and returning the current respectively. The forward voltage can therefore not be altered by e.g. a shunt switch shunting a part of the LED string. This way, the power consumed by the light source LED is regulated by the drivers powering the light source LED and not by changing the size of the light source LED. The light source LED may have two LED strings in parallel, preferably having approximately the same forward voltage. More details on this topology will be provided in further examples.

The controller C receives the dimming signal and uses this dimming signal for providing a first control signal for the first driver D1 and a second control signal for the second driver D2. Preferably, the controller C relates the dimming levels to corresponding power levels for the light source LED. The first driver D1 and the second driver D2 may be controlled by the controller C by providing a first control signal to the first driver D1 and a second control signal to the second driver D2. The first control signal may be used to enable and disable the first driver D1. The controller C may also provide a second control signal to the second driver D2. The second control signal may be used to enable and disable the second driver D2. By enabling and disabling the first driver D1 and the second driver D2 in a controllable fashion, the power to the light source LED can be regulated. Preferably, the drivers are controlled using a pulse width modulation, PWM, technique. This means that the drivers are enabled and disabled at a frequency with a dedicated on-time, also referred to as the duty cycle. Preferably, the frequency with which the PWM is generated is high enough that this does not impact the quality of light i.e., result in light flicker. The PWM frequency may be in the order of at least 100 Hz and preferably more than 1 kHz and even more preferred above 2 kHz. Preferably, when the drivers are providing power to the light source i.e., when the drivers are enabled, they provide power to the light source at their optimum current level. This means that the current amplitude provided to the light source does not change. Reducing the average current to the light source is then done by lowering the duty cycle i.e., the on-time of the drivers. Operating at the optimum current amplitude allows the drivers to operate at their maximum efficiency. A driver has an optimum operating point to which the design of the driver is dedicated. The dedicated design result into a current amplitude at which the driver provides the power to the light source LED at its highest efficiency. Operating at this optimum current amplitude may also be referred to as operating at the optimum power conversion efficiency of the driver.

As an example, the total power provided by the driver circuit to the light source LED is 10 W. In the example, two drivers are used to provide power to the light source LED. As an example, both drivers are arranged to provide identical maximum powers to the light source. This means that the first driver D1 is arranged to provide a maximum power of 5 W to the light source LED and the second driver D2 is arranged to provide a maximum power of 5 W to the light source LED. The controller C receives a dimming signal. As an example, the controller C may determine that at a dimming range between 0% and 50%, only the first driver D1 is arranged to provide a power to the light source LED. The second driver D2 may be disabled such that no power is provided to the light source LED by the second driver D2.

At a dimming level of 0%, preferably, the first driver D1 is arranged to provide no power to the light source LED.

At a dimming level between 1% and 50%, the controller C may provide a first control signal to the first driver D1. As an example, the first control signal provides a duty cycle to the first driver D1 that corresponds to the dimming level. For example, at a dimming level of 25%, the first driver D1 may receive a duty cycle of 50%. This means that the first driver D1 provides power to the light source LED for 50% of the time, resulting in 2.5 W to be provided to the light source LED. At a dimming level of 50%, the first driver D1 may receive a duty cycle of 100%. This means that the first driver D1 provides power to the light source LED for 100% of the time, resulting in 5 W to be provided to the light source LED.

At dimming levels between 51% and 100%, the second driver D2 may be controlled to contribute power to the light source LED next to the first driver D1. At this dimming range, the first driver D1 may be controlled to provide a power at a duty cycle at 100%. As an example, at a dimming level of 75%, the first driver D1 may be arranged to provide a power at a duty cycle of 100%, therefore providing 5 W and the second driver D2 is then arranged to provide power at a duty cycle of 50%, therefore providing 2.5 W. The total power provided to the light source LED is 7.5 W. At a dimming level of 100%, the first driver D1 may be arranged to provide a power at a duty cycle of 100%, therefore providing 5 W and the second driver D2 is then arranged to provide power at a duty cycle of 100%, therefore providing 5 W. The total power provided to the light source LED is 10 W.

Alternatively, the first driver D1 and the second driver D2 may be configured to provide power simultaneously over the dimming range with adjusted duty cycles. As an example, at a dimming level of 25%, both the first driver D1 and the second driver D2 may be controlled to operate at a duty cycle of 25%. This allows both the first driver D1 and the second driver D2 to provide 1.25 W to the light source LED, resulting in a total power of 2.5 W to be provided to the light source LED. At a dimming level of 50%, both the first driver D1 and the second driver D2 may be controlled to operate at a duty cycle of 50%. This allows both the first driver D1 and the second driver D2 to provide 2.5 W to the light source LED, resulting in a total power of 5 W to be provided to the light source LED. At a dimming level of 100%, both the first driver D1 and the second driver D2 may be controlled to operate at a duty cycle of 100%. This allows both the first driver D1 and the second driver D2 to provide 5 W to the light source LED, resulting in a total power of 10 W to be provided to the light source LED. For the sake of simple understanding, the duty cycles of operating the first driver D1 and the second driver D2 are chosen to be the same. Other combinations are also possible to achieve the desired power to the light source at a dedicated dimming level.

Another example may be that the first driver D1 and the second driver D2 provide different amounts of maximum powers to the light source LED. As an example, the total power provided by the driver circuit to the light source LED is 10 W. The first driver D1 may be designed to be able to provide a maximum power of 4 W and the second driver D2 is designed to be able to provide a maximum power of 6 W. As an example, the controller C may determine that at a dimming range between 0% and 40%, only the first driver D1 is arranged to provide a power to the light source LED. The second driver D2 may be disabled such that no power is provided by the second driver D2. At a dimming level of 0%, preferably, the first driver D1 is arranged to provide no power to the light source LED. At a dimming level between 1% and 40%, the controller C may provide a first control signal to the first driver D1. As an example, the first control signal provides a duty cycle to the first driver D1 that corresponds to the dimming level. For example, at a dimming level of 20%, the first driver D1 may receive a duty cycle of 50%. This means that the first driver D1 provides power to the light source LED for 50% of the time, resulting in 2 W to be provided to the light source LED. At a dimming level of 40%, the first driver D1 may receive a duty cycle of 100%. This means that the first driver D1 provides power to the light source LED for 100% of the time, resulting in 4 W to be provided to the light source LED. At dimming levels between 41% and 100%, the second driver D2 may be controlled to contribute power to the light source LED next to the first driver D1. At this dimming range, the first driver D1 may be controlled to provide a power at a duty cycle at 100%. As an example, at a dimming level of 70%, the first driver D1 may be arranged to provide a power at a duty cycle of 100%, therefore providing 4 W and the second driver D2 is then arranged to provide power at a duty cycle of 50%, therefore providing 3 W. The total power provided to the light source LED is 7 W. At a dimming level of 100%, both the first driver D1 and the second driver D2 may be controlled to operate at a duty cycle of 100%. This allows the first driver D1 to provide 4 W to the light source LED and the second driver D2 to provide 6 W to the light source LED, resulting in a total power of 10 W to be provided to the light source LED.

Alternatively, the first driver D1 and the second driver D2 may be configured to provide power simultaneously over the dimming range with adjusted duty cycles. As an example, at a dimming level of 25%, both the first driver D1 and the second driver D2 may be controlled to operate at a duty cycle of 25%. This allows the first driver D1 to provide 1 W to the light source LED and the second driver D2 to provide 1.5 W to the light source LED, resulting in a total power of 2.5 W to be provided to the light source LED. At a dimming level of 50%, both the first driver D1 and the second driver D2 may be controlled to operate at a duty cycle of 50%. This allows the first driver D1 to provide 2 W to the light source LED and the second driver D2 to provide 3 W to the light source LED, resulting in a total power of 5 W to be provided to the light source LED. At a dimming level of 100%, both the first driver D1 and the second driver D2 may be controlled to operate at a duty cycle of 100%. This allows the first driver D1 to provide 4 W to the light source LED and the second driver D2 to provide 6 W to the light source LED, resulting in a total power of 10 W to be provided to the light source LED. For the sake of simple understanding, the duty cycles of operating the first driver D1 and the second driver D2 are chosen to be the same. Other combinations are also possible to achieve the desired power to the light source at a dedicated dimming level.

When both drivers provide power simultaneously as described in this example, the power losses are distributed among both drivers, allowing a better thermal distribution over the driver circuit to be achieved.

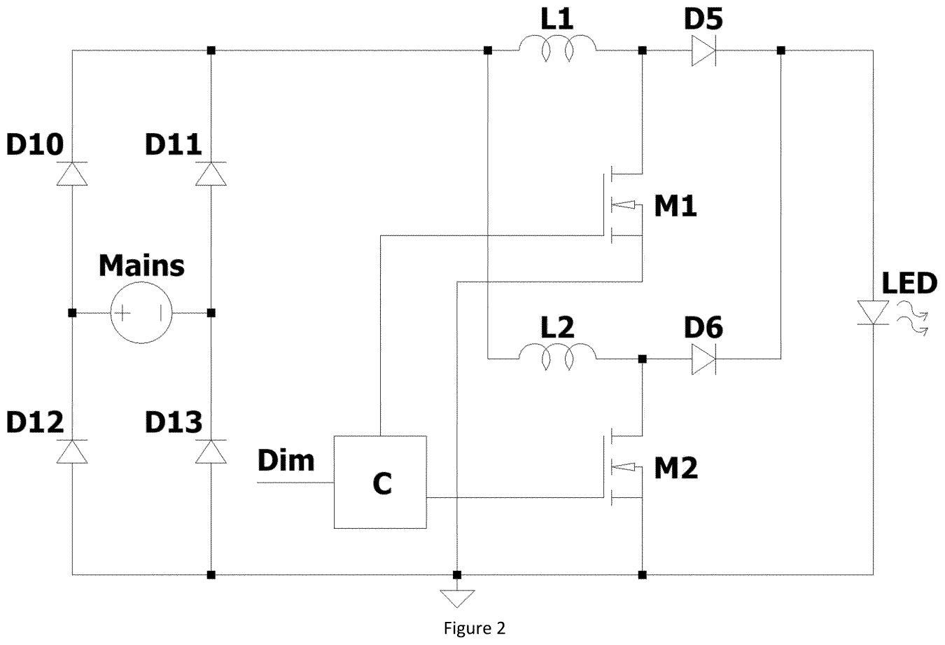

FIG. 2 shows an example of a detailed circuit diagram of the circuit shown in FIG. 1. In the example provided, a rectifier circuit D10, D11, D12, D13 is provided. The rectifier circuit provides a rectified voltage which is provided to the first driver D1 and the second driver D2. The first driver D1 and the second driver D2 are designed as boost converters. The first driver D1 and the second driver D2 are coupled in parallel at their inputs and provide a parallel power to the light source LED. The first driver D1 has a first inductor L1, a first switching element M1 and a first diode D5. The second driver D2 has a second inductor L2, a second switching element M2 and a second diode D6. The first diode D5 and second diode D6 provide two functions. The diodes form the freewheel diodes for the boost converter topology and they allow the outputs of the first driver D1 and the second driver D2 to be coupled together. In the case that another topology than the boost converter, e.g. a buck converter, an additional diode may be needed for each driver to allow the drivers to be coupled at their outputs. The controller C provides control signals for the first driver D1 and the second driver D2. In this example, the control signals may be directly provided at the gate of the first switching element M1 and the second switching element M2 respectively. The controller C therefore determines the power that can be delivered to the light source LED. Preferably, the controller C controls the drivers such that the power provided to the light source LED corresponds to power required for the light source LED according to the dimming levels. The controller C may control the first switching element M1 and the second switching element M2 with a PWM signal at a relatively high frequency of e.g. 200 kHz or more. This high frequency PWM signal is used for the boost converters to operate properly and provide a regulated current amplitude to the light source LED. In addition to this high frequency PWM signal, a low frequency signal may be superimposed at the gate of the respective switching elements. This low frequency PWM signal may be provided based on the enabling or disabling of the respective switching element. When a driver is to be disabled, the corresponding switching element is maintained off. Therefore, no power will be provided during the off moment of the switching element during the low frequency off time. The low frequency PWM signal may have a frequency of preferably in the proximity of 2 kHz. This prevents any visible effects in the light output to be perceived. In this example, the enabling and disabling of the drivers is done by direct interaction of the controller C with the first switching element M1 and the second switching element M2.

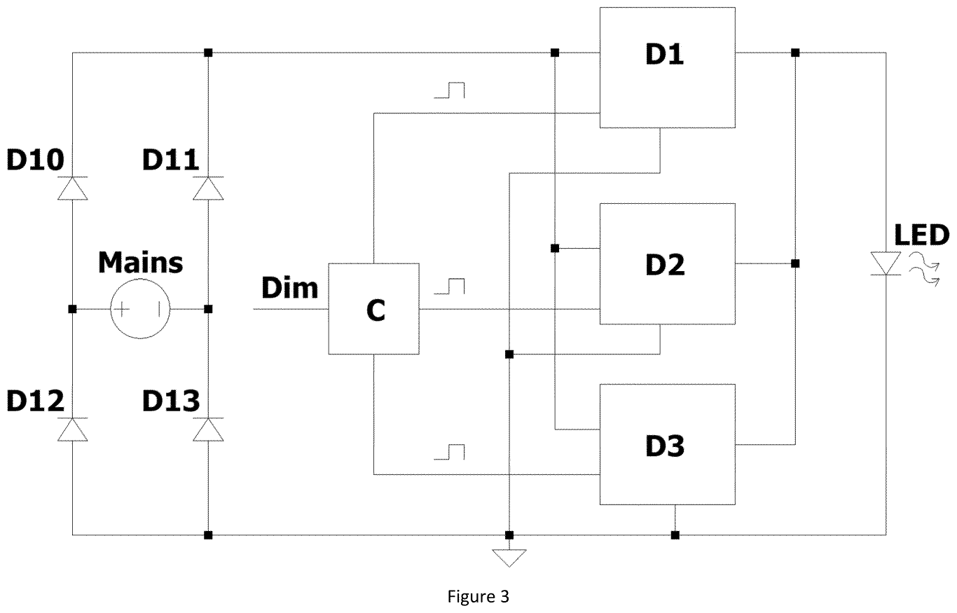

FIG. 3 shows an example of a circuit diagram of a lighting apparatus having a driver circuit that provides an output power to the light source LED. The driver circuit may be coupled to mains via a rectifier circuit having four diodes D10, D11, D12 and D13. The rectifier circuit provides a rectified mains voltage. In the example provided, a first driver D1, a second driver D2 and a third driver D3 receive the rectified mains voltage. A controller C is used to control the first driver D1 and the second driver D2. The controller C may receive a dimming signal Dim. The dimming signal Dim may be provided by a dimmer or an external device providing dimming commands. Examples of devices that can provide the dimming signal are phase-cut dimmers, 0-10 V dimmers, DALI dimmers, DMX dimmers or wireless remote devices for providing dimming signals. The first driver D1 and the second driver D2 are arranged to provide power to the same load, which is in this example a light source LED. The light source LED has a first input to which the output of the first driver D1, the output of the second driver D2 and the output of the third driver D3 are coupled.

Preferably, the light source LED is an LED light source. The LED light source may be a string of LEDs coupled in series, preferably forming a filament. Other devices or a combination of devices may also be coupled in series such as laser diodes or VCSEL. For the sake of clarity, the examples show LEDs as the light source. Preferably, the size of the LED string cannot be changed. This means that the LED string has only one input and one return for receiving a current and returning the current respectively. The forward voltage can therefore not be altered by e.g. a shunt switch shunting a part of the LED string. This way, the power consumed by the light source LED is regulated by the drivers powering the light source LED and not by changing the size of the light source LED. The light source LED may have two LED strings in parallel, preferably having approximately the same forward voltage. More details on this topology will be provided in further examples.

The controller C receives the dimming signal and uses this dimming signal for providing control signals for the first driver D1, the second driver D2 and the third driver D3. Preferably, the controller C relates the dimming levels to corresponding power levels for the light source LED. The first driver D1, the second driver D2 and the third driver D3 may be controlled by the controller C by providing a first control signal to the first driver D1, a second control signal to the second driver D2 and a third control signal for the third driver D3. The first control signal may be used to enable and disable the first driver D1. The controller C may also provide a second control signal to the second driver D2. The second control signal may be used to enable and disable the second driver D2. The third control signal may be used to enable and disable the third driver D3. By enabling and disabling the first driver D1, the second driver D2 and the third driver D3 in a controllable fashion, the power to the light source LED can be regulated. Preferably, the drivers are controlled using a pulse width modulation, PWM, technique. This means that the drivers are enabled and disabled at a frequency with a dedicated on-time, also referred to as the duty cycle. Preferably, the frequency with which the PWM is generated is high enough that this does not impact the quality of light i.e., result in light flicker. The PWM frequency may be in the order of at least 100 Hz and preferably more than 1 kHz and even more preferred above 2 kHz. Preferably, when the drivers are providing power to the light source i.e., when the drivers are enabled, they provide power to the light source at their optimum current level. This means that the current amplitude provided to the light source does not change. Reducing the average current to the light source is then done by lowering the duty cycle i.e., the on-time of the drivers. Operating at the optimum current amplitude allows the drivers to operate at their maximum efficiency. A driver has an optimum operating point to which the design of the driver is dedicated. The dedicated design result into a current amplitude at which the driver provides the power to the light source LED at its highest efficiency. Operating at this optimum current amplitude may also be referred to as operating at the optimum power conversion efficiency of the driver.

As an example, the total power provided by the driver circuit to the light source LED is 12 W. In the example, three drivers are used to provide power to the light source LED. As an example, all three drivers are arranged to provide identical maximum powers to the light source. This means that the first driver D1 is arranged to provide a maximum power of 4 W to the light source LED, the second driver D2 is arranged to provide a maximum power of 4 W to the light source LED and the third driver D3 is arranged to provide a maximum power of 4 W to the light source LED. The controller C receives a dimming signal. As an example, the controller C may determine that at a dimming range between 0% and 33.33%, only the first driver D1 is arranged to provide a power to the light source LED. The second driver D2 and the third driver D3 may be disabled such that no power is provided to the light source LED by the second driver D2 and the third driver D3.

At a dimming level of 0%, preferably, the first driver D1 is arranged to provide no power to the light source LED.

At a dimming level between 1% and 33.33%, the controller C may provide a first control signal to the first driver D1. As an example, the first control signal provides a duty cycle to the first driver D1 that corresponds to the dimming level. For example, at a dimming level of 11.11%, the first driver D1 may receive a duty cycle of 33.33%. This means that the first driver D1 provides power to the light source LED for 33.33% of the time, resulting in 1.33 W to be provided to the light source LED.

At a dimming level of 33.33%, the first driver D1 may receive a duty cycle of 100%. This means that the first driver D1 provides power to the light source LED for 100% of the time, resulting in 4 W to be provided to the light source LED. At dimming levels between 33.34% and 66.66%, the second driver D2 may be controlled to contribute power to the light source LED next to the first driver D1. At this dimming range, the first driver D1 may be controlled to provide a power at a duty cycle at 100%. As an example, at a dimming level of 44.44%, the first driver D1 may be arranged to provide a power at a duty cycle of 100%, therefore providing 4 W and the second driver D2 is then arranged to provide power at a duty cycle of 33.33%, therefore providing 1.33 W. The total power provided to the light source LED is 5.33 W. At a dimming level of 66.66%, the first driver D1 and the second driver D2 may receive a duty cycle of 100%. This means that the first driver D1 and the second driver D2 provide power to the light source LED for 100% of the time, resulting in 8 W to be provided to the light source LED.

At dimming levels between 66.67% and 100%, the third driver D3 may be controlled to contribute power to the light source LED next to the first driver D1 and the second driver D2. At this dimming range, the first driver D1 and the second driver D2 may be controlled to provide a power at a duty cycle at 100%. As an example, at a dimming level of 77.77%, the first driver D1 and the second driver D2 may be arranged to provide a power at a duty cycle of 100%, therefore providing 8 W and the third driver D3 is then arranged to provide power at a duty cycle of 33.33%, therefore providing 1.33 W. The total power provided to the light source LED is 9.33 W. At a dimming level of 100%, the first driver D1, the second driver D2 and the third driver D3 may receive a duty cycle of 100%. This means that the first driver D1, the second driver D2 and the third driver D3 provide power to the light source LED for 100% of the time, resulting in 12 W to be provided to the light source LED.

Another example may be that the first driver D1, the second driver D2 and the third driver D3 provide different amounts of maximum powers to the light source. As an example, the total power provided by the driver circuit to the light source LED is 18 W. The first driver D1 may be designed to be able to provide a maximum power of 3 W, the second driver D2 is designed to be able to provide a maximum power of 6 W and the third driver D3 may be designed to be able to provide a maximum power of 9 W. As an example, the controller C may determine that at a dimming range between 0% and 16.67%, only the first driver D1 is arranged to provide a power to the light source LED. The second driver D2 and the third driver D3 may be disabled such that no power is provided by the second driver D2 and the third driver D3.

At a dimming level of 0%, preferably, the first driver D1 is arranged to provide no power to the light source LED.

At a dimming level between 1% and 16.67%, the controller C may provide a first control signal to the first driver D1. As an example, the first control signal provides a duty cycle to the first driver D1 that corresponds to the dimming level. For example, at a dimming level of 8.33%, the first driver D1 may receive a duty cycle of 50%. This means that the first driver D1 provides power to the light source LED for 50% of the time, resulting in 1.5 W to be provided to the light source LED. At a dimming level of 16.67%, the first driver D1 may receive a duty cycle of 100%. This means that the first driver D1 provides power to the light source LED for 100% of the time, resulting in 3 W to be provided to the light source LED.

At dimming levels between 16.68% and 50%, the second driver D2 may be controlled to contribute power to the light source LED next to the first driver D1. At this dimming range, the first driver D1 may be controlled to provide a power at a duty cycle at 100%. As an example, at a dimming level of 33.33%, the first driver D1 may be arranged to provide a power at a duty cycle of 100%, therefore providing 3 W and the second driver D2 is then arranged to provide power at a duty cycle of 50%, therefore providing 3 W. The total power provided to the light source LED is 6 W. At a dimming level of 50%, both the first driver D1 and the second driver D2 may be controlled to operate at a duty cycle of 100%. This allows the first driver D1 to provide 3 W to the light source LED and the second driver D2 to provide 6 W to the light source LED, resulting in a total power of 9 W to be provided to the light source LED.

At dimming levels between 50.1% and 100%, the third driver D3 may be controlled to contribute power to the light source LED next to the first driver D1 and the second driver D2. At this dimming range, the first driver D1 and the second driver D2 may be controlled to provide a power at a duty cycle at 100%. As an example, at a dimming level of 75%, the first driver D1 and the second driver D2 may be arranged to provide a power at a duty cycle of 100%, therefore providing a total of 9 W to the light source LED and the third driver D3 is then arranged to provide power at a duty cycle of 50%, therefore providing 4.5 W. The total power provided to the light source LED is 13.5 W.

At a dimming level of 100%, the first driver D1, the second driver D2 and the third driver D3 may be controlled to operate at a duty cycle of 100%. This allows the first driver D1 to provide 3 W to the light source LED, the second driver D2 to provide 6 W to the light source LED and the third driver to provide 9 W to the light source LED, resulting in a total power of 18 W to be provided to the light source LED.

Alternatively, the first driver D1, the second driver D2 and the third driver D3 may be configured to provide power simultaneously over the dimming range with adjusted duty cycles. As an example, at a dimming level of 25%, the first driver D1, the second driver D2 and the third driver D3 may be controlled to operate at a duty cycle of 25%. This allows the first driver D1, the second driver D2 and the third driver D3 to provide 1 W to the light source LED, resulting in a total power of 3 W to be provided to the light source LED. At a dimming level of 50%, the first driver D1, the second driver D2, the third driver D3 may be controlled to operate at a duty cycle of 50%. This allows the first driver D1, the second driver D2 and the third driver to provide 2 W to the light source LED, resulting in a total power of 6 W to be provided to the light source LED. At a dimming level of 100%, the first driver D1, the second driver D2 and the third driver D3 may be controlled to operate at a duty cycle of 100%. This allows both the first driver D1 and the second driver D2 to provide 5 W to the light source LED, resulting in a total power of 10 W to be provided to the light source LED. For the sake of simple understanding, the duty cycles of operating the first driver D1 and the second driver D2 are chosen to be the same. Other combinations are also possible to achieve the desired power to the light source at a dedicated dimming level.

When both drivers provide power simultaneously as described in this example, the power losses are distributed among the drivers, allowing a better thermal distribution over the driver circuit to be achieved.

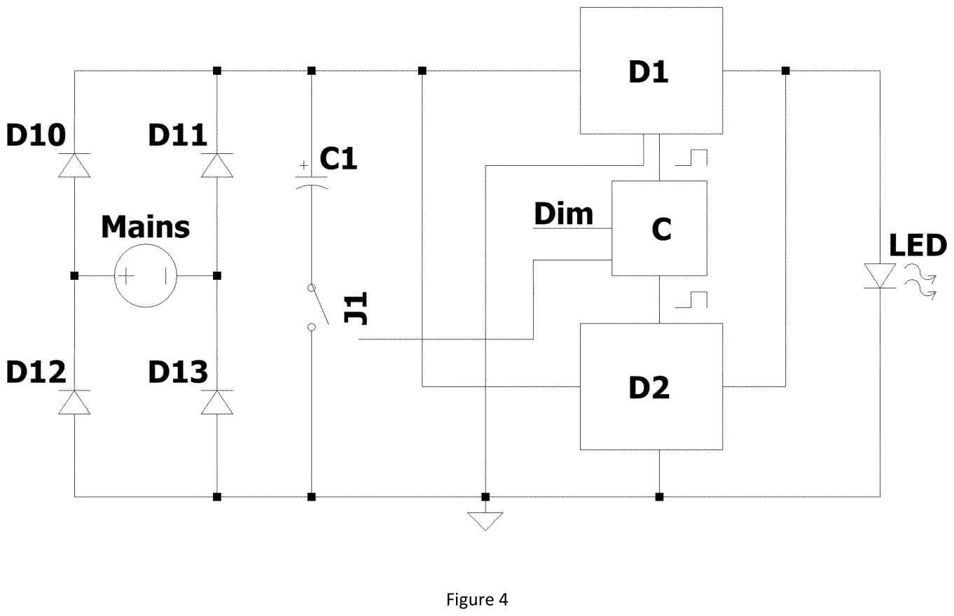

FIG. 4 shows an example of a circuit diagram of a lighting apparatus having a driver circuit that provides an output power to the light source LED. The lighting apparatus may be designed according to any of the designs provided in any of the previous examples. Two or more drivers may be provided. Using a PWM signal for enabling and disabling the drivers may result in a disturbance of the current drawn from the input e.g., mains. Especially in the event when number of active drivers varies, the input current may vary, resulting in a current waveform that may not comply with power factor requirements.

A series configuration of a buffer capacitor C1 and a switch J1 may be provided at the output of the rectifier circuit D10, D11, D12, D13. The switch is shown as a simple controllable switching element, but additional circuit may be provided for performing the required functions i.e., controlling the flow of current through the buffer capacitor C1. This means that instead of a switch, a switching device may be used having one or more switching elements and control circuitry. The switch J1 may be controlled by the controller C. The switch J1 is used to regulate a current through the buffer capacitor C1. This allows the buffer capacitor C1 to be charged and discharged in a controlled manner. The buffer capacitor C1 may be used to draw a current from the mains when no or not enough current is drawn by any of the drivers. This allows the current from the mains to be smoothened. Preferably, the controller C controls the switch J1 and the driver such that the driver circuit provides power factor correction. This means that the current drawn from the mains is following the waveform of the voltage. The mains voltage may e.g. be a sinus at a frequency of 50 Hz or 60 Hz. The waveform of the current is then such that the waveform follows this voltage waveform in phase. This can also be achieved by having a common input PFC (Power Factor Correction) stage placed between the rectifier and the driver D1 and D2. The common PFC stage draws a sinusoidal current from the mains and a buffer capacitor placed at the output of the PFC stage acts as a buffer for the pulsating current drawn by the driver D1 and D2.

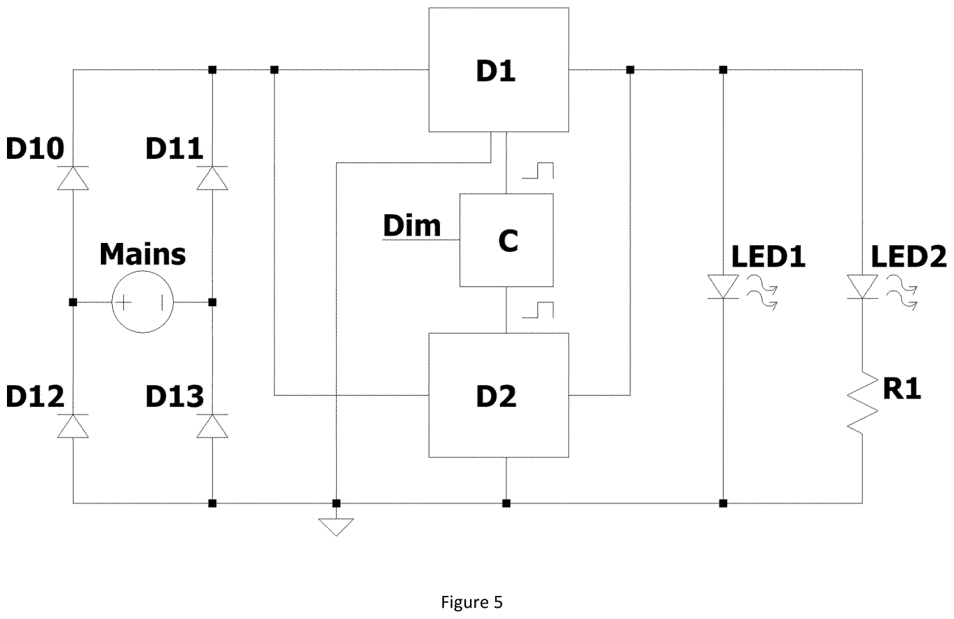

FIG. 5 shows a circuit diagram of a lighting apparatus with a further simple example of an improved light source LED that can operate with the driver circuit as provided in the examples. The light source LED receives power from the driver circuit. The light source LED has a first LED load LED1 and a second LED load LED2. The first LED load LED1 and the second LED load LED2 are coupled in parallel. Preferably, the first LED load LED1 has a forward voltage that is higher than the forward voltage of the second LED load LED2. A resistor R1 is placed in series with the second LED load LED2. The driver circuit as provided in the examples provides a current that may vary based on the amount of drivers that provide the power to the light source. At a relatively low current, all current will flow through the second LED load LED2 and resistor R1. The sum of the forward voltage of the second LED load LED2 and the voltage drop over the resistor R1 is lower than the forward voltage of the first LED load LED1. If the current increases, the forward voltage of the second LED load LED2 will only increase slightly, but a more significant voltage will drop over the resistor R1. Further increasing the current to the light source LED will cause the sum of the forward voltage of the second LED load LED2 and the voltage drop over the resistor R1 to increase until this sum reaches or exceeds the forward voltage of the first LED load LED1. At his increased current, the first LED load LED1 will also start conducting. Increasing or decreasing the current to the light source therefore allows a simple distribution of the current through the first LED load LED1 and the second LED load LED2 to be achieved. Preferably, the first LED load LED1 is a cold white LED load and the second LED load LED2 is a warm white LED load. At a low current, mainly the warm white LEDs are active while at an increased current, the cold white LEDs also become active. This allows for a very simple mimicking of a dimmable incandescent filament or halogen lamp.

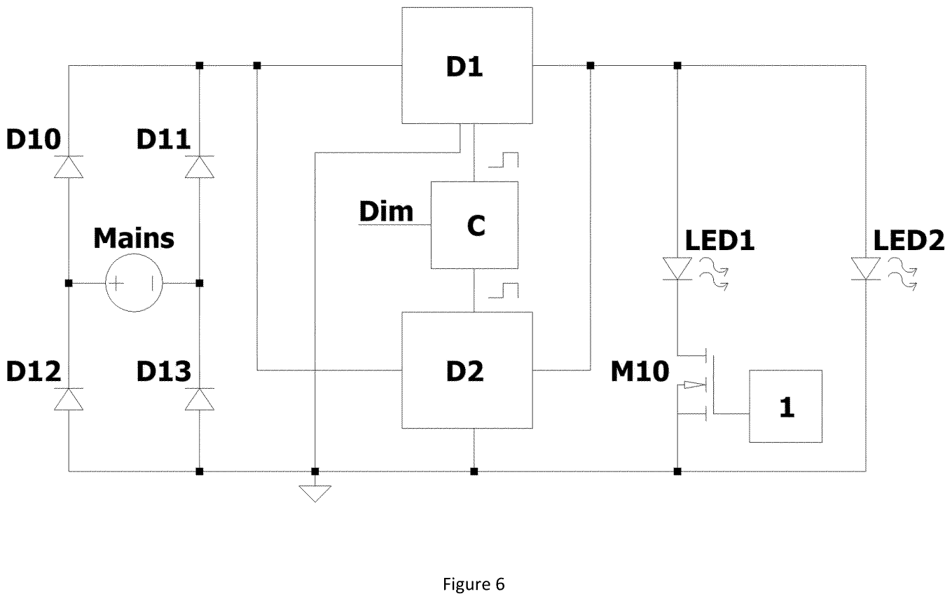

FIG. 6 shows a circuit diagram of a lighting apparatus with a simpler example of an improved light source LED that can operate with the driver circuit as provided in the examples. The light source LED receives power from the driver circuit. The light source LED has a first LED load LED1 and a second LED load LED2. The first LED load LED1 and the second LED load LED2 are coupled in parallel. Preferably, the first LED load LED1 has a forward voltage that is lower than the forward voltage of the second LED load LED2. Preferably, the first LED load LED1 and the second LED load LED2 are provided as filaments. The first LED load LED1 and the second LED load LED2 are shown as single LEDs but more LEDs can be coupled in series as to form a string of LEDs or a filament. A first series switch M10 is provided in series with the first LED load LED1. A control circuit 1 is arranged to control the first series switch M10. The control circuit is arranged to sense a parameter of the voltage or current provided by the driver circuit. Examples of the parameters may be a frequency, a duty cycle or an amplitude of the voltage or current. The parameter is used by the control circuit 1 to determine how the first series switch M10 is controlled. As an example, a frequency modulation on the voltage or current provided by the driver circuit may provide information for the control circuit 1 to control the first series switch M10. As an example, a frequency modulation may provide an indication for the control circuit 1 to close the first series switch M10, where an absence of the modulation may provide an indication for the control circuit 1 to open the first series switch M10. When the first series switch M10 is open, the current provided by the driver circuit can only flow through the second LED load LED2. When the first series switch M10 is open, the current provided by the driver circuit can flow through the first LED load LED1. When the forward voltage of the first LED load LED1 is approximately identical to the forward voltage of the second LED load LED2, the closing of the first series switch M10 will allow a current to flow through both the first LED load LED1 and the second LED load LED2. If the forward voltage of the first LED load LED1 is lower than the forward voltage of the second LED load LED2, the current will only flow through the first LED load LED1. As another example, a similar control can be provided by changing the amplitude of the voltage or the current provided by the driver circuit. A change in voltage may change the control of the first series switch M10. An advantage of control of the light source LED configuration according to the above-mentioned examples is that with only two wires, power and data can be sent from the driver circuit to the light source, which is especially beneficial when the light source LED is designed as a filament in a bulb, such as a retrofittable bulb with e.g. a screw or bayonet base. In such situation, the number of wires that can be provided through the stem may be limited. Using the dimming technique provided in the examples allow an easy dimming of the filaments, while the control circuit 1 allows to distribute the provided power among the filaments. Preferably, the first LED load LED1 and the second LED load LED2 have different colors or color temperatures from each other. Preferably, the first LED load LED1 has a warm color temperature and the second LED load LED2 has a cold color temperature. The parameter can therefore be used to allow the control circuit 1 to regulate the color or color temperature that is emitted by the light source LED. The opening and closing of the first series switch M10 can be a time continuous process where the first series switch M10 is open or closed with a duty cycle e.g., a PWM control. Preferably, this switching process is performed with a frequency above 100 Hz and more preferably above 2 kHz. Alternatively, to provide for a simple control for the control circuit 1, the opening and closing of the first series switch M10 can be a single event, e.g. at start-up of the lighting apparatus. During operation, the open or closed state of the first series switch M10 can be altered by a different command, e.g. a command for changing the color or color temperature.

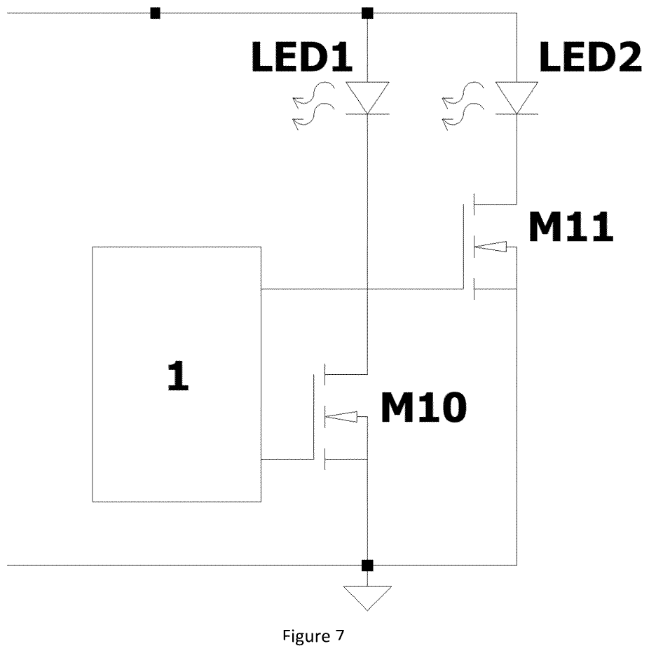

FIG. 7 shows an example of a circuit diagram where an improved light source LED is provided that can operate with the driver circuit as provided in the examples. The light source LED receives power from the driver circuit. The light source LED has a first LED load LED1 and a second LED load LED2. The first LED load LED1 and the second LED load LED2 are coupled in parallel. Preferably, the first LED load LED1 and the second LED load LED2 have an approximately identical forward voltage. Preferably, the first LED load LED1 and the second LED load LED2 are provided as filaments. The first LED load LED1 and the second LED load LED2 are shown as single LEDs but more LEDs can be coupled in series as to form a string of LEDs or a filament. A first series switch M10 is provided in series with the first LED load LED1. A second series switch M11 is provided in series with the second LED load LED2. A control circuit 1 is arranged to control the first series switch M10 and the second series switch M11. The control circuit is arranged to sense a parameter of the voltage or current provided by the driver circuit. Examples of the parameters may be a frequency, a duty cycle or an amplitude of the voltage or current. The parameter is used by the control circuit 1 to determine how the first series switch M10 and the second series switch M11 are controlled. As an example, a frequency modulation on the voltage or current provided by the driver circuit may provide information for the control circuit 1 to determine which of the series switches is to be controlled. As an example, a frequency modulation of 1 kHz may provide an indication for the control circuit 1 to close the first series switch M10 and open the second series switch M11, where a 2 kHz modulation may cause the first series switch M10 to open and the second series switch M11 to close and a 3 kHz modulation may cause the first series switch M10 to close and the second series switch M11 to close. As another example, a similar control can be provided by changing the amplitude of the voltage or the current provided by the driver circuit. A change in voltage or current may change the control of the first series switch M10 and the second series switch M11. An advantage of control of the light source LED configuration according to the above-mentioned examples is that with only two wires, power and data can be sent from the driver circuit to the light source, which is especially beneficial when the light source LED is designed as a filament in a bulb, such as a retrofittable bulb with e.g. a screw or bayonet base. In such situation, the number of wires that can be provided through the stem may be limited.

Using the dimming technique provided in the examples allow an easy dimming of the filaments, while the control circuit 1 allows to distribute the provided power among the filaments. Preferably, the first LED load LED1 and the second LED load LED2 have different colors or color temperatures from each other. Preferably, the first LED load LED1 has a warm color temperature and the second LED load LED2 has a cold color temperature. The parameter can therefore be used to allow the control circuit 1 to regulate the color or color temperature that is emitted by the light source LED. The opening and closing of the first series switch M10 and the second series switch M11 can be a time continuous process where either the first series switch M10 is closed or the second series switch M11 is closed, each with their own duty cycle e.g., a PWM control. Preferably, this switching process is performed with a frequency above 100 Hz and more preferably above 2 kHz. Alternatively, to provide for a simple control for the control circuit 1, the opening and closing of the first series switch M10 and the second series switch M11 can be a single event, e.g. at start-up of the lighting apparatus. During operation, the open or closed state of the first series switch M10 and the second series switch M11 can be altered by a different command, e.g. a command for changing the color or color temperature.

In the examples provided, the controller C, and additional peripheral electrical components, may also be powered using a dedicated power supply. An auxiliary power supply may be provided that is used to power the controller C. Preferably, the auxiliary power supply is electrically isolated from the light source LED. The auxiliary power supply is therefore a dedicated power supply for the controller C. The auxiliary power supply is not able to provide power to the light source LED and therefore can be optimized for powering the controller C.

During a stand-by mode of the lighting apparatus, no power is to be provided to the light source LED and therefore the drivers can be turned off. The controller C may however be required to operate in a stand-by mode for e.g. receiving control commands for activating the lighting apparatus. The controller C then requires less power than during the operation mode of the lighting apparatus. A further auxiliary power supply may be provided to power the controller C and peripheral electrical components during the standby. The further auxiliary is optimized for powering the controller C in the stand-by mode.

In the examples provided the drivers may be separate devices with separate components. To improve the use of space and components, some components may be re-used among the drivers.

In the examples provided, the dimming levels relate linearly with the power required for the light source LED. Other relations such as a logarithmic or non-linear may also be conceivable and lead to the desired effects.

In the examples provided, it is desired to vary the duty cycle of only one driver when cycling through the dimming levels.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A driver circuit for powering a light source, the driver circuit comprising:
a first driver adapted to provide power to the light source and having a first output power at a first optimum power conversion efficiency;
a second driver adapted to provide power to the light source and having a second output power at a second optimum power conversion efficiency;
a controller adapted to:
generate a first control signal for enabling and disabling the first driver, the first control signal having a first duty cycle, and
generate a second control signal for enabling and disabling the second driver, the second control signal having a second duty cycle,
wherein the controller is adapted to receive a dimming signal and arranged to determine the first duty cycle and the second duty cycle based on the dimming signal such that the first driver operates at the first optimum power conversion efficiency and the second driver operates at the second optimum power conversion efficiency when active,
wherein the first control signal and the second control signal have a frequency of at least 100 Hz.

2. The driver circuit according to claim 1, further comprising a third driver adapted to provide power to the light source and having a third output power at a third optimum power conversion efficiency, wherein the controller is arranged to provide a third control signal for enabling and disabling the third driver with a third duty cycle and adapted to determine the third duty cycle based on the dimming signal such that the third driver operates at the third optimum power conversion efficiency when active.

3. The driver circuit according to claim 1, wherein the first driver and the second driver are arranged to have identical rated powers.

4. The driver circuit according to claim 1, wherein the first driver and the second driver are arranged to have different rated powers from each other.

5. The driver circuit according to claim 1, wherein the first driver and/or the second driver are non-dimmable.

6. The driver circuit according to claim 1, further comprising a capacitor and a switching element wherein the capacitor and the switching element form a series configuration between a first input of the first driver and a second input of the first driver.

7. The driver circuit according to claim 6, wherein the driver circuit is arranged to receive an AC voltage and wherein the switching element is arranged to be closed when a voltage across the capacitor exceeds an amplitude of an AC momentary voltage.

8. The driver circuit according to claim 1, further comprising an auxiliary driver, adapted to power the controller and adapted to be electrically separated from the light source.

9. The driver circuit according to claim 1, further comprising a further auxiliary driver, wherein the further auxiliary driver is adapted to power the controller when the driver circuit is in a standby mode.

10. The driver circuit according to claim 1, wherein at a dimming level, where the first driver and the second driver provide power to the light source, the first driver and the second driver operate in an interleaved mode of operation.

11. The driver circuit according to claim 1, wherein the controller is arranged to control the first driver to operate at a duty cycle of 100% and the second driver at a duty cycle between 0% and 100% from a dimming level representing a required power for the light source exceeding a rated power of the first driver.

12. The driver circuit according to claim 1, wherein the controller is arranged to enable the first driver and the second driver by providing a control signal to the first driver and the second driver and wherein the controller is arranged to disable the first driver and the second driver by not providing the control signal to the first driver and the second driver.

13. A lighting apparatus comprising:
the driver circuit according to claim 1; and
the light source.

14. The lighting apparatus according to claim 13, wherein the controller is arranged to control the first driver and the second driver based on the dimming level such that an efficacy of the lighting apparatus increases when the dimming level decreases.

15. The lighting apparatus according to claim 13, wherein the light source is a semiconductor light source.
